(19) United States
(12) Patent Application Publication
(10) Pub. No.: US 2025/0262578 A1
(43) Pub. Date: Aug. 21, 2025

(54) WATER FILTER ASSEMBLY AND METHOD FOR FLOW RECOVERY

(71) Applicant: Haier US Appliance Solutions, Inc., Wilmington, DE (US)

(72) Inventors: Amin Firouzi, Louisville, KY (US); Gregory Sergeevich Chernov, Louisville, KY (US); Thomas Earl McKeehan, Louisville, KY (US)

(21) Appl. No.: 18/442,729

(22) Filed: Feb. 15, 2024

(51) Int. Cl. B01D 35/06; B01D 35/143; B01D 35/16; B01D 37/04; B01D 39/20; C02F 1/00; F25D 23/12

(52) U.S. Cl. CPC B01D 35/06; B01D 35/143; B01D 35/16; B01D 37/043; B01D 39/2055; C02F 1/003; F25D 23/126; B01D 2201/08; C02F 2307/12; F25D 2323/121

(57) ABSTRACT

A water filtration assembly, a method for self-cleaning at a fluid filter assembly, and a refrigeration appliance are provided. The water filtration assembly includes a filtration housing forming a first volume configured to receive unfiltered water, and a second volume configured to receive filtered water. A filter medium separates the first volume from the second volume. An electrolytic cell includes a first electrode formed at the filter medium and a second electrode extended into the first volume. The electrolytic cell is configured to reverse polarity to reverse an ionic current through the electrolytic cell to restore permeability at the filter medium. A power supply or delivery system is operably coupled to the electrolytic cell and is configured to selectively apply a potential difference between the first electrode and the second electrode and selectively reverse a polarity of the applied potential.

### FIELD OF THE INVENTION

The present subject matter relates generally to refrigerator appliances, and more particularly to a system and method for cleaning a filter for a water filtration assembly of a refrigerator appliance.

### BACKGROUND OF THE INVENTION

Water filtration assemblies, such as for refrigerator appliances, standalone kitchen vessels, or mainline water filtration, can filter water entering the water filtration assembly, such as to improve taste, appearance, or remove undesired particulates. Certain refrigerator appliances may include water filter assemblies for filtering water. Water filter assemblies can filter water entering the refrigerator appliances to provide filtered water to various refrigerator appliance components, such as an ice maker and/or a water dispenser.

Over a period of usage, flowrate of water or other fluid through filter assemblies may generally decrease, such as due to build-up of filtered particulates at a filter medium. Decreases in flowrate can slow water filtration, such as to render the water filter unusable, too slow, or insufficient volume for a user. At such time, the water filter, or the water filtration assembly, may generally be replaced.

However, removal, disposal, and replacement of water filters can be wasteful, or can present issues to the user with finding, removing, and replacing the water filter.

Additionally, water filter assemblies for appliances may include one or more features that require power, such as various lights, sensors, valves, actuators, filtration means, hardware, etc. Conventionally, the water is routed in and out of the filter assembly through a filter manifold, which is generally a permanent component of the refrigerator appliance. As such, the power is typically transferred or supplied to the internal electronic components of the water filter assemblies via integration of electrical connections into the manifold. However, power through the manifold can increase the risk of water exposure to the electronic components of the filter assembly. In addition, routing the power through the manifold can also increase the complexity of the design of the manifold, which may inhibit integration of systems and methods for operating a water filtration assembly that use or modulate voltage or current at the water filtration assembly.

A water filtration assembly addressing one or more of the aforementioned issues would be beneficial and advantageous. Additionally, an appliance including a water filtration assembly addressing one or more of the aforementioned issues would be beneficial and advantageous.

### BRIEF DESCRIPTION OF THE INVENTION

Aspects and advantages of the invention will be set forth in part in the following description, or may be obvious from the description, or may be learned through practice of the invention.

An aspect of the present disclosure is directed to a method for self-cleaning at a fluid filter assembly. The method includes disposing unfiltered fluid into a first volume enclosed in a housing. The unfiltered fluid is in fluid communication at a first side of a filter medium including a first electrode. A second volume is formed at a second side of the filter medium at which filtered fluid is disposable. The method includes applying a potential difference between the first electrode at the filter medium and a second electrode positioned at the first volume. The method includes reversing, for a period of time, a polarity of the applied potential. Reversing the polarity reverses an ionic current at an electrolytic cell including the first electrode and the second electrode.

Another aspect of the present disclosure is directed to a water filtration assembly including a filtration housing forming a first end distal from a second end. The first end includes one or more of a fluid inlet port or a fluid outlet port fixed to the filtration housing. The filtration housing forms a first volume configured to receive unfiltered water. The filtration housing forms a second volume configured to receive filtered water. A first electrode including a filter medium is positioned at the filtration housing and separates the first volume from the second volume. A second electrode extends into the first volume. A power delivery system is operably coupled to an electrolytic cell including the first electrode and the second electrode. The power delivery system is configured to selectively apply a potential difference between the first electrode and the second electrode. The power delivery system is configured to selectively reverse a polarity of the applied potential.

Still another aspect of the present disclosure is directed to a refrigeration appliance. The refrigeration appliance includes a cabinet defining a chilled chamber and a water filtration assembly. The water filtration assembly includes a filtration housing forming a first end distal from a second end. The first end includes one or more of a fluid inlet port or a fluid outlet port fixed to the filtration housing. The filtration housing forms a first volume configured to receive unfiltered water. The filtration housing forms a second volume configured to receive filtered water. A filter medium is positioned at the filtration housing and separates the first volume from the second volume. An electrolytic cell includes a first electrode and a second electrode. The filter medium forms the first electrode, and the second electrode extends into the first volume. The electrolytic cell is configured to reverse polarity to reverse an ionic current through the electrolytic cell to restore permeability at the filter medium. A power supply system is operably coupled to the electrolytic cell. The power supply system is configured to selectively apply a potential difference between the first electrode and the second electrode. The power supply system is configured to selectively reverse a polarity of the applied potential.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides an elevation view of a refrigerator appliance according to exemplary embodiments of the present disclosure.

FIG. 2 provides a perspective view of the exemplary refrigerator appliance of FIG. 1.

FIG. 3 provides an elevation view of the exemplary refrigerator appliance of FIG. 1 wherein the doors are shown in an open position.

FIG. 4 provides a simplified side elevation view of an embodiment of a water filtration assembly within a refrigerator appliance according to exemplary embodiments of the present disclosure.

FIG. 5 provides a perspective view of a water filtration assembly, including an illustration of a second electrical contact sub-assembly separated from the rest of the water filtration assembly for clarity.

FIG. 6 provides an exploded perspective view of the exemplary water filtration assembly of FIG. 5.

FIG. 7A provides a side perspective view of the water filter of the exemplary water filtration assembly of FIG. 5.

FIG. 7B provides a cross-sectional perspective view of the water filter of the exemplary water filtration assembly of FIG. 5.

FIG. 7C provides an exploded perspective view of the water filter of the exemplary water filtration assembly of FIG. 5.

FIG. 8 provides a cross-sectional perspective view of the housing cap of the exemplary water filtration assembly of FIG. 5.

FIG. 9 provides a cross-sectional perspective view of a portion of the filter label of the exemplary water filtration assembly of FIG. 5.

FIG. 10 provides a perspective view of a portion of the housing cap of the exemplary water filtration assembly of FIG. 5.

FIG. 11 provides a simplified side perspective view of an embodiment of a water filtration assembly within a refrigerator appliance according to exemplary embodiments of the present disclosure.

FIG. 12 provides an exploded perspective view of the water filter of the exemplary water filtration assembly of FIG. 11.

FIG. 13A provides a side perspective view of a water filter of an exemplary water filtration assembly in accordance with aspects of the present disclosure.

FIG. 13B provides a cross-sectional perspective view of the water filter of the exemplary water filtration assembly of FIG. 13A.

FIG. 13C provides an exploded perspective view of the water filter of the exemplary water filtration assembly of FIG. 13A.

FIG. 14A provides a perspective view of a water filter of an exemplary water filtration assembly, with components removed for clarity, in accordance with an embodiment of the present disclosure.

FIG. 14B provides an exploded perspective view of a water filter of an exemplary water filtration assembly, with components removed for clarity, in accordance with an embodiment of the present disclosure.

FIG. 15 provides a schematic side view of a water filter of an exemplary water filtration assembly in accordance with an embodiment of the present disclosure.

FIG. 16 provides a schematic plan view of a water filter of an exemplary water filtration assembly in accordance with an embodiment of the present disclosure.

FIG. 17 provides a schematic view of a water filter of an exemplary water filtration assembly in accordance with an embodiment of the present disclosure.

FIG. 18 provides a flowchart outlining steps of a method for operating a water filtration assembly in accordance with aspects of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

Embodiments of a water filter, filtration system, and methods are generally provided herein. It should be appreciated that embodiments provided herein may form fluid filter assemblies and methods for water and water-based solutions generally, or other appropriate solutions.

Generally, the present disclosure is directed to a filtration system and method for maintaining or improving flow characteristic, such as, flowrate, pressure drop, or other characteristic corresponding to flow across a filtration medium to a filtered fluid. Embodiments depicted and described herein include an electrochemical configuration to remove ions, particles, debris, or other particulates from water and filter medium by application of a potential difference between a first electrode, such as an activated carbon medium, and a second electrode, such as a conductive electrode (e.g., metal, conductive polymer, ceramic, carbon, etc.). The filtration system includes a electrolytic cell configured as a cathode and an anode electrode. A power supply system or power delivery system may be configured to supply or deliver controlled voltage or current output at the electrolytic cell. A measuring system may be configured to measure or determine a flow characteristic, such as, flowrate, pressure drop, time-in-service, volume-in-service, or other parameter or characteristic corresponding to a quality or quantity of flow across the filtration medium. A control system may be configured to selectively apply voltage or current at the electrolytic cell based on a period of time or a flow characteristic threshold. The control system may be configured to receive or transmit signals corresponding to flow characteristic, determine quantity or quality of flow across the filtration medium.

Embodiments of the method for maintaining or improving flow characteristic at the filtration system include applying a potential difference between the first and second electrodes. Applying the potential difference may perform an oxidation-reduction (redox) reaction to form coagulated particles of dissolved particulates from the fluid. The coagulated particles may be captured and precipitated on the filter medium, such as a carbon or carbon-based material. As precipitated particles accumulate on the filter medium, the flow characteristic corresponding to a quantity or quality of flow across the filter medium may decrease (e.g., a flowrate of fluid across the filter medium may decrease). The control system reverses a polarity of the applied potential, such as via the power supply or power delivery system. The change in polarity reverses a flow of ionic current in the electrolytic cell, such as to form a gap between a surface of the filter medium and a sediment layer. Forming the gap may restore permeability of the filter medium, such as to improve the flow characteristic or maintain the flow characteristic at a desired level, such as to facilitate flowing clean water through the filter medium without obstruction by the precipitated particles. In some embodiments, the control system reverses the polarity of the applied potential based on a period of time (e.g., a predetermined frequency of polarity reversal), or when a determined flow characteristic exceeds a predetermined threshold.

Embodiments of the filtration system may be configured as a standalone fluid filter assembly, such as a water filter assembly including a reservoir to receive filtered water, or as an appliance configured to receive the filtration system, such as a refrigeration appliance.

Embodiments provided herein may desirably increase life and usability of a water filter, improve flowrate or pressure drop across the filter medium, or improve an accuracy of determination of a need for filter replacement. Assemblies and methods provided herein may reduce waste, reduce or remove a need for filter replacement, or reduce a need for a user to replace a filter.

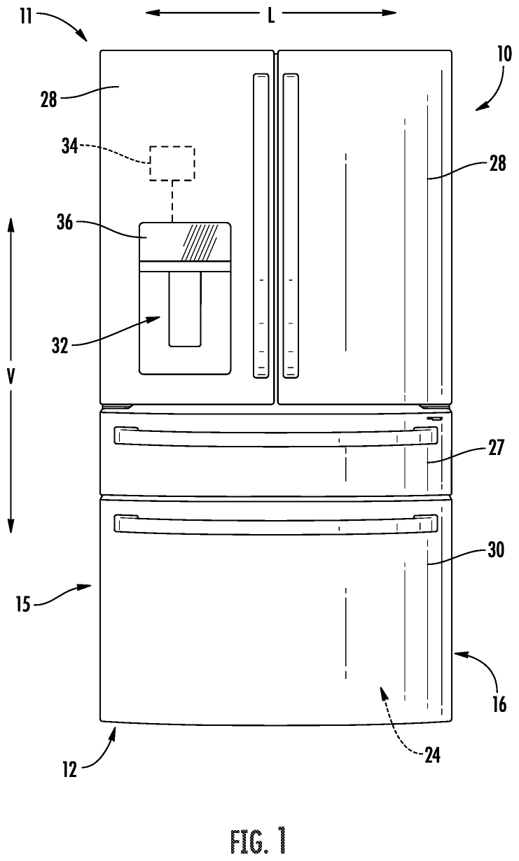

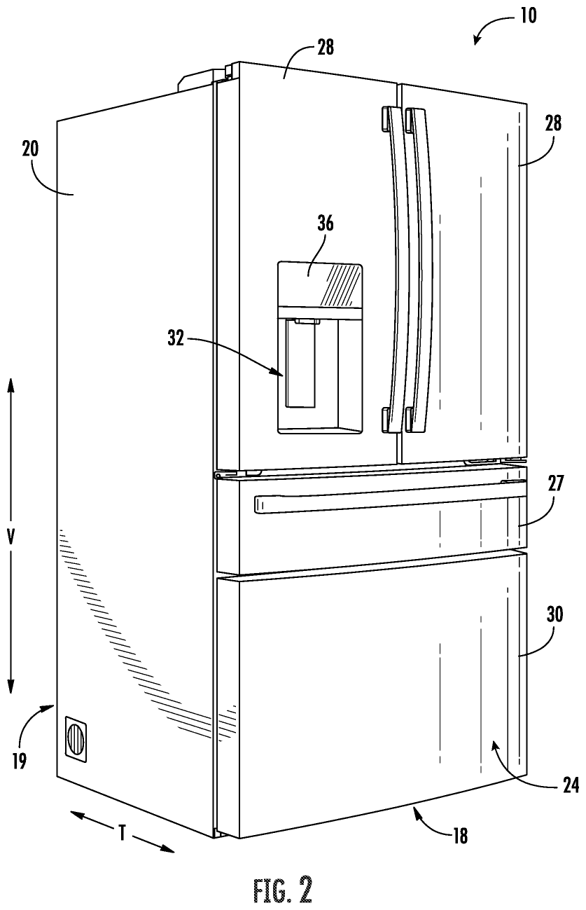

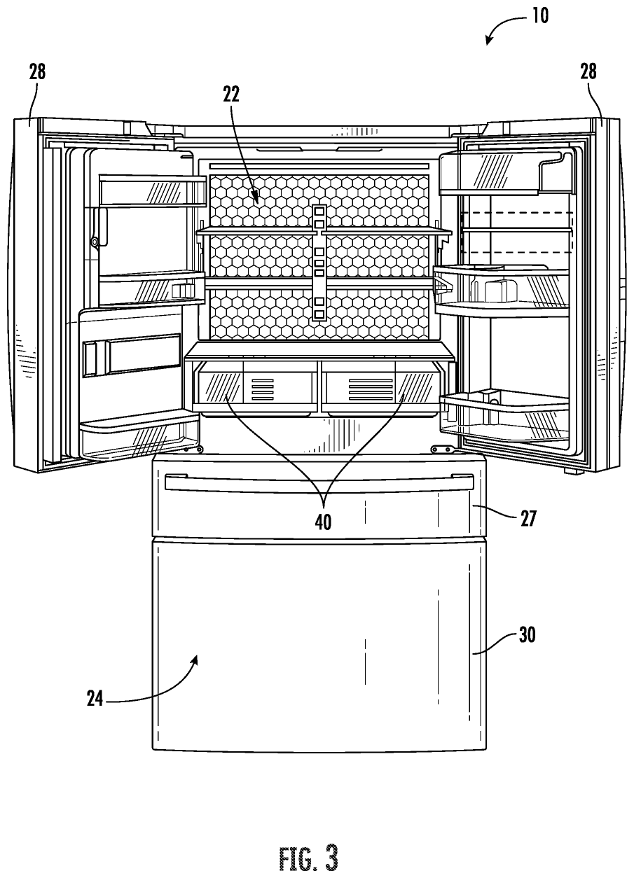

Referring now to the drawings, FIG. 1 illustrates a front view of an embodiment of a refrigerator appliance 10 according to an embodiment of the present disclosure. FIG. 2 illustrates a perspective view of the refrigerator appliance 10 of FIG. 1. FIG. 3 illustrates a front view of the refrigerator appliance 10 of FIG. 1 with refrigerator doors 28 in an open position. Referring particularly to FIG. 1 the refrigerator appliance 10 extends between a top 11 and a bottom 12 along a vertical direction V. The refrigerator appliance 10 also extends between a first side 15 and a second side 16 along a lateral direction L. As shown in FIG. 2, a transverse direction T may additionally be defined perpendicular to the vertical and lateral directions V, L. The refrigerator appliance 10 extends along the transverse direction T between a front portion 18 and a back portion 19.

The refrigerator appliance 10 may include a cabinet or housing 20 (FIG. 2) defining an upper fresh food chamber 22 (FIG. 3) and a lower freezer storage chamber 24 arranged below the upper fresh food chamber 22 along the vertical direction V. An auxiliary food storage chamber may be positioned between the upper fresh food chamber 22 and the lower freezer storage chamber 24, e.g., along the vertical direction V. Because the lower freezer storage chamber 24 is positioned below the upper fresh food chamber 22, the refrigerator appliance 10 may be generally referred to as a bottom mount refrigerator. In the embodiment, the housing 20 may also define a mechanical compartment (not shown) for receipt of a sealed cooling system (not shown). Using the teachings disclosed herein, one of ordinary skill in the art will understand that the present technology can be used with other types of refrigerators (e.g., side-by-side) or a freezer appliance as well. Consequently, the description set forth herein is for illustrative purposes only and is not intended to limit the technology in any aspect.

Referring now particularly to FIG. 3, the refrigerator doors 28 may each be rotatably hinged to an edge of the housing 20 for accessing the upper fresh food chamber 22. It should be noted that while two refrigerator doors 28 in a “French door” configuration are illustrated, any suitable arrangement of doors utilizing one, two or more doors is within the scope and spirit of the present disclosure. A freezer door 30 may be arranged below the refrigerator doors 28 for accessing the lower freezer storage chamber 24. In the embodiment, the freezer door 30 is coupled to a freezer drawer (not shown) slidably mounted within the lower freezer storage chamber 24. An auxiliary door 27 may be coupled to an auxiliary drawer which may be slidably mounted within the auxiliary chamber.

Referring back to FIG. 1 operation of the refrigerator appliance 10 can be regulated by a controller 34 that is operatively coupled to a user interface panel 36. The user interface panel 36 may provide selections for user manipulation of the operation of the refrigerator appliance 10 to modify environmental conditions therein, such as temperature selections, etc. In some embodiments, the user interface panel 36 is proximate a dispenser assembly 32. In response to user manipulation of the user interface panel 36, the controller 34 may operate various components of the refrigerator appliance 10. Operation of the refrigerator appliance 10 may be regulated by the controller 34, e.g., the controller 34 may regulate operation of various components of the refrigerator appliance 10 in response to programming and/or user manipulation of the user interface panel 36.

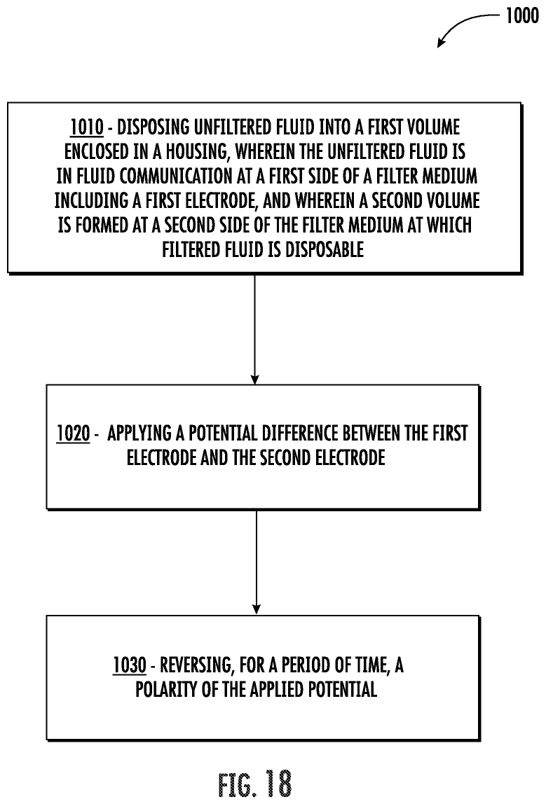

The controller 34 may include a memory and one or more microprocessors, CPUs, or the like, such as general or special purpose microprocessors operable to execute programming instructions or micro-control code associated with operation of the refrigerator appliance 10. The memory may represent random access memory such as DRAM, or read only memory such as ROM or FLASH. In one embodiment, the processor executes programming instructions stored in memory. The memory may be a separate component from the processor or may be included onboard within the processor. It should be noted that controller(s) 34 as disclosed herein are capable of and may be operable to perform any methods and associated method steps as disclosed herein, such as one or more steps of method 1000 (FIG. 18).

The controller 34 may be positioned in a variety of locations throughout the refrigerator appliance 10. In the illustrated embodiment, the controller 34 is located within the refrigerator doors 28. In such an embodiment, input/output (“I/O”) signals may be routed between the controller and various operational components of the refrigerator appliance 10. In one embodiment, the user interface panel 36 represents a general purpose I/O (“GPIO”) device or functional block. In one embodiment, the user interface panel 36 includes input components, such as one or more of a variety of electrical, mechanical or electro-mechanical input devices including rotary dials, push buttons, and touch pads. The user interface panel 36 may include a display component, such as a digital or analog display device designed to provide operational feedback to a user. For example, the user interface panel 36 may include a touchscreen providing both input and display functionality. The user interface panel 36 may be in communication with the controller via one or more signal lines or shared communication busses.

Using the teachings disclosed herein, one of skill in the art will understand that the present disclosure can be used with other types of refrigerators such as a refrigerator/freezer combination, side-by-side, bottom mount, compact, and any other style or model of refrigerator appliance. Accordingly, other configurations of the refrigerator appliance 10 could be provided, it being understood that the configurations shown in the accompanying figures and the description set forth herein are by way of example for illustrative purposes only.

Embodiments of the filtration assembly 102 may be configured as a standalone fluid filter assembly, as components of a mainline filtration system, or as a portion of an appliance configured to receive the filtration system, such as the refrigeration appliance 10 depicted and described herein.

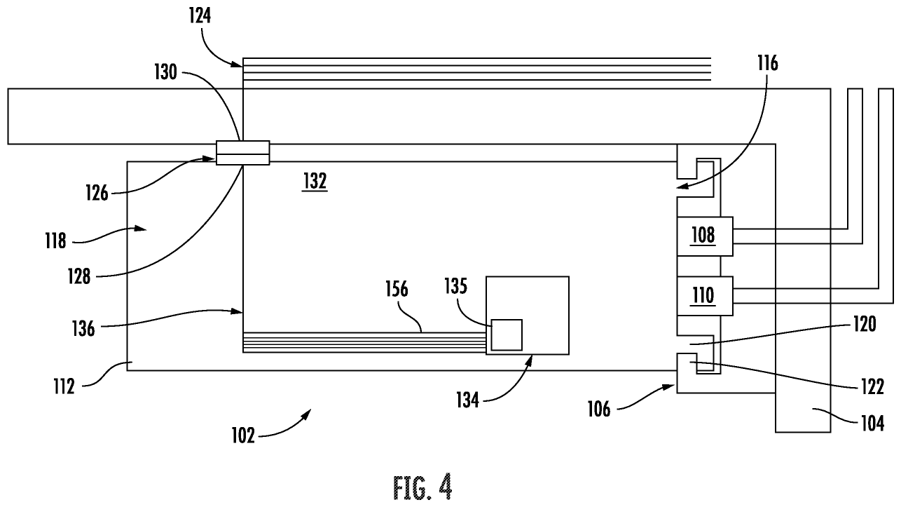

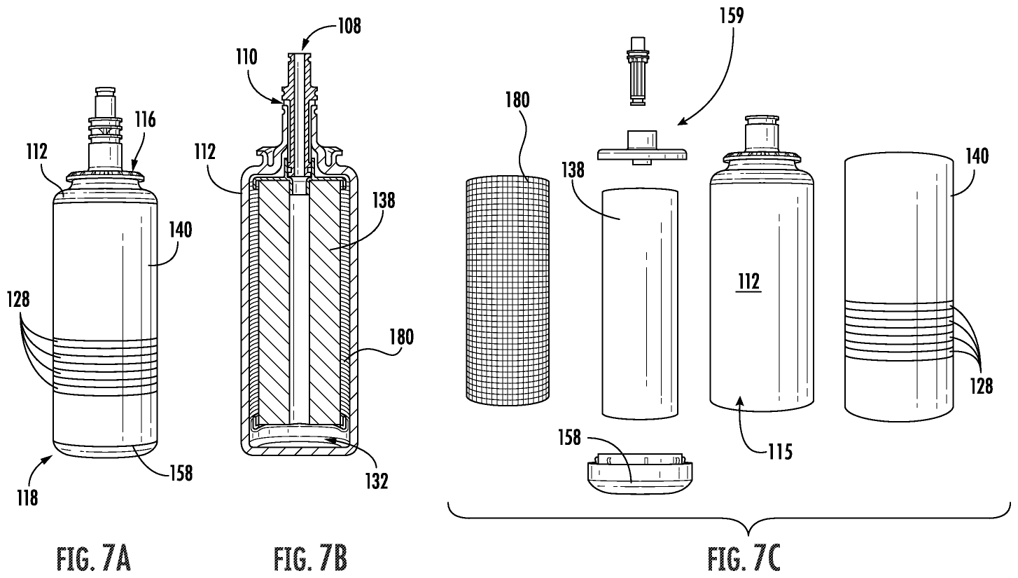

Referring now to FIG. 4, a simplified side view of an embodiment of an appliance wall 104 of an appliance 10 (such as an interior wall, an exterior wall, a side wall, etc.) having the water filtration assembly 102 secured thereto is illustrated. As shown, the water filtration assembly 102 has a filtration housing 112. As would be understood, a volume or mass of filtration media (e.g., water filtration cartridge or filter medium 138, such as depicted in FIGS. 7B and 7C) may be disposed within the filtration housing 112. Optionally, the filtration housing 112 may have a cylindrical configuration. In further embodiments, the filtration housing 112 may have any other suitable configuration other than a cylindrical configuration. Moreover, as shown, the water filtration assembly 102 may also include a liquid receiving space 132 within the filtration housing 112 and an electronics compartment 134 having one or more electronic components 135 (e.g., various lights, sensors, valves, actuators, filtration means, etc., as would be understood) housed, at least in part, therein. In such embodiments, the electronics compartment 134 is fluidly isolated from the liquid receiving space 132, and thus fluidly isolated from the flow of water received within the liquid receiving space 132.

In further embodiments, as shown, the water filtration assembly 102 may include a manifold 106 that can be mounted to the appliance wall 104 of the appliance 10. Accordingly, as shown, the manifold 106 may generally contain a filter latching/mating interface and water connections therein.

Generally, and as would be understood, the appliance 10 includes a water source (not shown) that provides water to and from the water filtration assembly 102 (e.g., through the manifold 106 via a water inlet 108 and a water outlet 110, such as depicted in FIG. 4). Thus, in certain embodiments, the water filtration assembly 102 is in fluid communication with the water inlet 108 and the water outlet 110. It is noted that although FIG. 4 illustrates a simplified view whereby the water inlet 108 and water outlet 110 are spaced apart (e.g., at the same end of filtration housing 112), alternative embodiments may provide a coaxial inlet-outlet configuration, or other suitable configuration for a separate inlet and outlet for a filtration assembly, as would be understood.

The filtration housing 112 includes a first end 116 opposite a second end 118. In optional embodiments, the first end 116 includes one or more features for securing the water filtration assembly 102 to the manifold 106 via the filter latching/mating interface, with the manifold 106 being secured to the appliance wall 104 of the appliance 10. For instance, the filter latching/mating interface may include the first end 116 of the filtration housing 112 having one or more interlocking features 120 and corresponding interlocking features 122 of the manifold 106. In some such embodiments, the interlocking features 120 of the first end 116 of the filtration housing 112 are configured to engage with the corresponding interlocking features 122 of the manifold 106 for securing the filtration housing 112 to the appliance 10. In further embodiments, the first end 116 of the filtration housing 112 may be secured to the manifold 106 using any other suitable means.

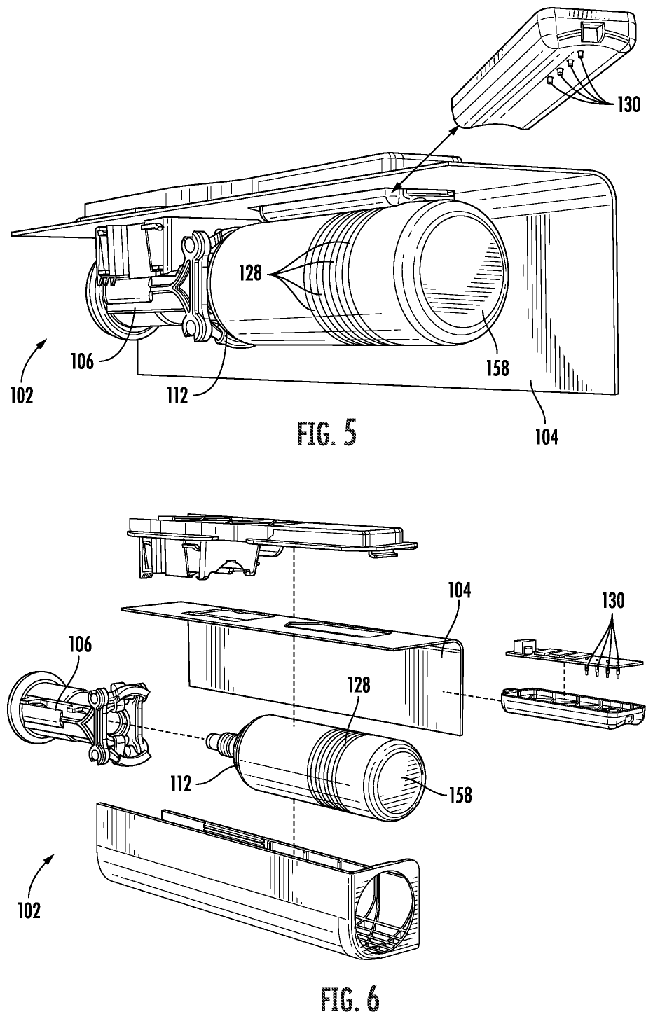

Referring still to FIG. 4, the water filtration assembly 102 further includes an electrical connection 126 electrically coupling the water filtration assembly 102 to a power source or a controller (e.g., controller 34, FIG. 1). Generally, the power source may be any suitable source of electricity. More specifically, as shown, the electrical connection 126 may include at least one first electrical contact 128 positioned on the filtration housing 112 and at least one second electrical contact 130 fixed to the cabinet 20 (e.g., positioned on the appliance wall 104 of the appliance 10). When installed or mounted to the appliance 10 (FIG. 4), the first electrical contact(s) 128 is configured to align with the second electrical contact(s) 130, details of which are further explained herein below with respect to FIGS. 5 through 11.

Generally, the electrical connection 126 may include one or more electrical harnesses 136, 124. For instance, a first electrical harness 136 includes various electrical paths (e.g., connected in series or parallel) and is configured to electrically couple the first electrical contact 128 to an electronics compartment 134 (FIG. 4) having one or more electronic components 135 (FIG. 4) housed within the filtration housing 112. Moreover, as shown, a second electrical harness 124 is configured to electrically couple the second electrical contact 130 to the power source or any other communication device, such as a controller 34 (FIG. 1).

Generally, the electrical connection 126 is separate and spaced apart from the manifold 106 and the flow of water received therein, e.g., separate and spaced apart from the water inlet port(s) 108 and the water outlet port(s) 110. As such, in an embodiment, when the first electrical contact(s) 128 contacts the second electrical contact(s) 130, power is provided to the water filtration assembly 102 from the power source, for example, via the electrical connection 126. Additionally, or alternatively, one or more other signals for communication, security, or sensing may also be provided to the water filtration assembly 102 when the first electrical contact(s) 128 contacts the second electrical contact(s) 130.

Generally, the housing label 140 is separate and spaced apart from the fluid inlet port 108 and the fluid outlet port 110. For instance, the housing label 140 may include an adhesive layer or coating (e.g., applied to an interior surface of the housing label 140, such as to contact an external surface of the filtration housing 112) that adheres or sticks to an external surface 115 of filtration housing 112. Additionally, or alternatively, a separate exterior label or coating (e.g., fitted polymer, such as a shrink wrap or vacuum-sealed layer) may be provided to hold housing label 140 to the filtration housing 112. Optionally, the housing label 140 may extend about at least a portion of filtration housing 112. As would be understood, housing label 140 may include printed text, labeling, or figures indicative or descriptive of the water filtration assembly 102. Nonetheless, as would also be understood, the present disclosure is not limited to any particular printed text, labeling, or figures.

Referring to FIG. 9, in some embodiments, an electrical connector 142 (e.g., electrical passthrough facilitating an electrical voltage or current to flow therethrough) is provided on, with, beneath, or through the housing label 140. Generally, the electrical connector 142 defines an intermediate electrical path 154 (e.g., singular path or, alternatively, plurality of electrically parallel paths) that extends outside (e.g., partially or, alternatively, fully outside) of at least a portion of the filtration housing 112. When assembled (e.g., such that filtration housing 112 is mounted within appliance in fluid connection with a water source), intermediate path may conduct power or communication signals between the water filtration assembly 102 and the separate appliance 10 (FIG. 4).

The electrical connector 142 may extend from a first connector end 144 to a second connector end 146. Generally, between the first connector end 144 and the second connector end 146 one or more circuit conductors (e.g., wires, conductive traces, pins, etc.) through which a current may be conducted between first connector end 144 and second connector end 146. In some embodiments, electrical connector 142 is joined to the housing label 140, such as between first connector end 144 and second connector end 146 (e.g., by an adhesive, attachment panel, embedding material, or other suitable conductor attachment structure, as would be understood). Optionally, both first connector end 144 and second connector end 146 (e.g., the entirety of electrical connector 142 between first connector end 144 and second connector end 146) may be disposed outside of the liquid receiving space 132, electronics compartment 134 (FIG. 4), or general interior of filtration housing 112.

In certain embodiments, first connector end 144 is defined as or at first electrical contact 128. Thus, the intermediate electrical path 154 may extend from the first electrical contact 128 to conduct power or communication signals between the water filtration assembly 102 and the separate appliance 10 (FIG. 4). In embodiments wherein multiple discrete contacts 128 are provided, a similar number of branches of intermediate electrical path 124 may be provided (e.g., in parallel to each other). In additional or alternative embodiments, second connector end 146 is defined as or at one or more housing contact pads 148. The contacts pads 148 may correspond (e.g., in number and placement) to the (e.g., parallel) electrical branches of path 154 or, alternatively, be distinct (e.g., in number and placement) from the (e.g., parallel) electrical branches of path 154 while still being in electrical communication with the same (e.g., directly or, alternatively, indirectly, such as through an electrical chip 170). Additionally, or alternatively, the contact pad(s) 148 may be disposed on or fixed to the external surface 115 of filtration housing 112. Optionally, the housing contact pads 148 may be disposed beneath or on an internal surface of housing label 140. When assembled the intermediate electrical path 154 may extend to the housing contact pad(s) 148 to conduct power or communication signals between the water filtration assembly 102 and the separate appliance 10 (FIG. 4).

Turning to FIGS. 5 through 10, the first electrical contact(s) 128 may include axially spaced pads. In particular, first electrical contact(s) 128 may be formed or be shaped as one more conductive rings. For instance, first electrical contact 128 may extend around at least a portion of filtration housing 112. Optionally, a plurality of first electrical contacts 128 may be provided as conductive rings. In particular, as shown, the water filtration assembly 102 may include a plurality of first electrical contacts 128 extending around at least a portion of the filtration housing 112. Optionally, a plurality of second electrical contacts 130 may be arranged on the appliance wall 104 of the appliance 10 (FIG. 4). Additionally, or alternatively, each of the plurality of first electrical contacts 128 may generally have a ring-shaped configuration extending around an entire circumference of filtration housing 112. Accordingly, the ring-shaped first electrical contact(s) 128 allow for the filtration housing 112 to be installed in any orientation such that, regardless of the orientation, the first electrical contact(s) 128 align with the second electrical contact(s) 130. In such embodiments, the ring-shaped first electrical contacts 128 may be arranged adjacent to each other and may be axially spaced apart from each other (e.g., equally spaced or separated by differing distances along the axis of the filtration housing 112). In the illustrated embodiment, four first electrical contacts 128 are provided, however, it should be understood that more than four or less than four first electrical contacts 128 may be employed in the water filtration assembly 102 of the present disclosure.

Moreover, as shown, each of the plurality of second electrical contacts 130 is arranged on the appliance wall 104 of the appliance 10 (FIG. 4) to align with and contact one of the plurality of first electrical contacts 128 when the water filtration assembly 102 is mounted within the appliance 10. In some embodiments, the second electrical contacts 130 include or are provided spring-loaded contact pins, such as pogo pins (e.g., as shown), biased outward or downward toward first electrical contacts 128, such as at contact surface 129. The second electrical contact 130 includes contact surface 129 configured to touch the first electrical contact 128. Thus, as shown in the illustrated embodiment, four second electrical contacts 130 are provided, however, it should be understood that more than four or less than four second electrical contacts 130 may be employed in the water filtration assembly 102 of the present disclosure, with the number of second electrical contacts 130 corresponding to the number of first electrical contacts 128.

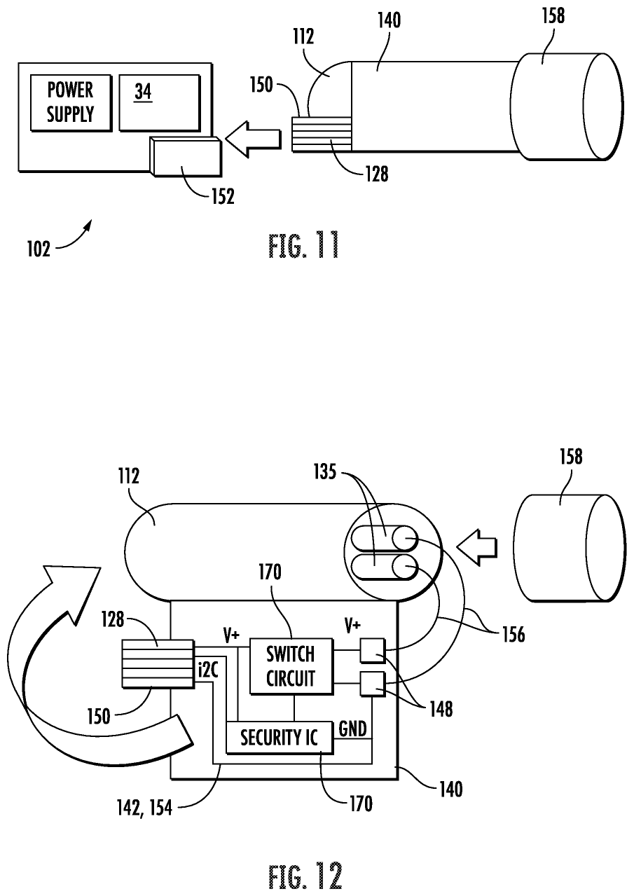

Turning briefly to FIGS. 11 and 12, although certain embodiments may include one or more conducive rings at the first electrical contacts 128, alternative embodiments may include a rigid card plug 150 (e.g., provided at or as part of the first electrical contact 128). Such a rigid card plug 150 may include, for instance, an edge connector having a printed circuit board including conductive traces or pathways leading to the edge of the board that are intended to plug into a matching contact socket 152. As shown, the rigid card plug 150 may extend outward from the housing label 140 (e.g., to the intermediate electrical path below the housing label 140).

The contact socket 152 may be fixed or mounted on the separate appliance 10 (FIG. 4), such as a female card socket to receive the rigid card plug 150. Moreover, the contact socket 152 may be in electrical communication with the power source or controller 34 (e.g., to direct power or communication signals between the appliance 10 (FIG. 4) and the water filtration assembly 102).

Returning generally to FIGS. 5 through 12, within the filtration housing 112, an internal electrical path 156 may be disposed in electrical communication with the intermediate electrical path 154. The internal electrical path 156 may connect the intermediate electrical path 154 to the one or more electronics components 135 (FIG. 4) provided within the filtration housing 112 (e.g., within the electronics compartment 134—FIG. 4). For instance, as noted above, one or more housing contact pads 148 may be provided (e.g., fixed on an external surface of) the filtration housing 112 to connect to the internal electrical path 156. In turn, the housing contact pads 148 may be in electrical communication between the internal electrical path 156 and the intermediate electrical path 154.

In some embodiments, the internal electrical path 156 may be connected to the intermediate electrical path 154 or housing contact pads 148 through one or more intermediary connectors. For instance, a housing cap 158 may be selectively disposed on the filtration housing 112 (e.g., to close the first housing end 116 or second housing end 118). Fixed to the housing cap 158 may be one or more cap contact pads 160 in electrical communication with the internal electrical path 156. When assembled, the cap contact pads 160 may thus be in electrical communication between the internal electrical path 156 and the intermediate electrical path 154.

In certain embodiments, the cap contact pads 160 circumferentially align with and conductively contact the housing contact pads 148. For instance, the cap contact pads 160 may be embedded from an exterior surface of the housing cap 158 at a circumferential rim 162 thereof while one or more mated conductor bodies 164 extend inward through the circumferential rim 162 to the interior of the filtration housing 112. In some such embodiments, the cap contact pads 160 are overmolded within the housing cap 158. The housing label 140 may cover at least a portion of the circumferential rim 162 such that the housing contact pads 148 sit over or radially outward from the cap contact pads 160 (e.g., at the same circumferential location about the filtration housing 112). In turn, an intermediate electrical connection may be formed between the contact pads 148, 160 to permit electrical communication between the two paths 154, 156.

As noted above, the conductor bodies 164 may extend from the cap contact pads 160. In optional embodiments, each conductor body 164 includes a conductive trunk 166 that extends from the cap contact pad 160 and a plurality of conductive branches 168 held within the filtration housing 112. Thus, a discrete conductor body 164 or conductive trunk 166 may extend from each discrete cap contact pad 160. As shown, each of the conductive branches 168 may be circumferentially spaced apart from each other within filtration housing 112. Optionally, the discrete branches 168 of one conductive trunk 166 may be circumferentially interposed between the discrete branches 168 of another conductive trunk 166 such that two or more branches 168 of one conductive trunk 166 are circumferentially interrupted or separated by the branch 168 of another conductive trunk 166. Additionally, or alternatively, a radial collar within filtration housing 112 may radially separate the conductive branches 168 of two or more conductive trunks 166 (e.g., such that the radial collar surface acts as a radially barrier between the two sets of branches 168). Thus, one set of conductive branches 168 may be arranged radially inward of another set of conductive branches 168.

Turning now especially to FIGS. 9 and 12, a validating electrical circuit or electrical chip 170 may be disposed along the intermediate electrical path (e.g., on the housing label 140). Specifically, between the first connector end 144 and the second connector end 146, the electrical chip 170 may be positioned to interrupt electrical communication or the conductive lines in general. Included on the electrical chip 170 may be one or more electrical components, circuits, or processors (e.g., configured to selectively restrict/permit power or communication signals through the electrical chip 170, as would be understood in light of the present disclosure). In some embodiments, the electrical chip 170 is configured to evaluate one or more electrical signals from the first electrical contact 128 and selectively permit power transfer through the electrical chip 170 to the filtration housing 112 based on the evaluation. For instance, the electrical chip 170 may include a Field-Effect Transistor (FET) circuit configured to selectively permit or restrict electrons through the electrical chip 170. Additionally, or alternatively, the electrical chip 170 may include a chip processor or controller configured to receive an authentication communication signal from the controller 34 and match the authentication communication signal to a stored condition. In response to matching the authentication communication signal, the chip processor or controller may permit power or communication signals through the electrical chip 170 (e.g., to the internal electrical path 156). Alternately, if the chip processor or controller of chip 170 fails to match the authentication communication signal, the chip processor or controller may be configured to restrict or prevent power or communication signals through the electrical chip 170 (e.g., to the internal electrical path 156).

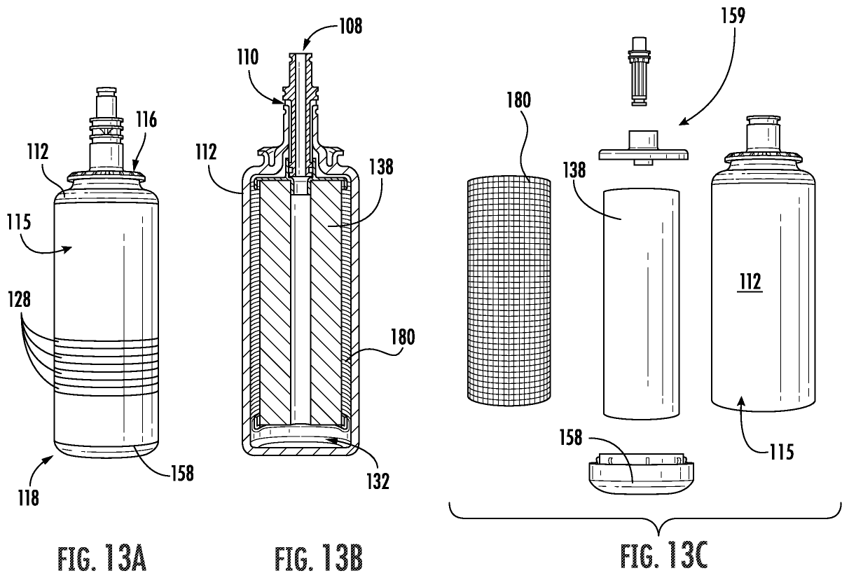

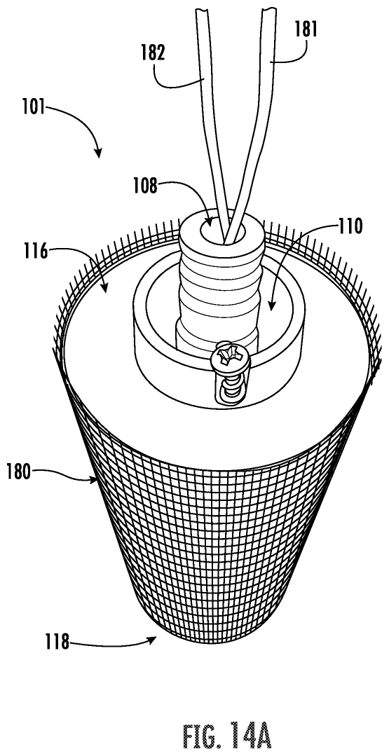

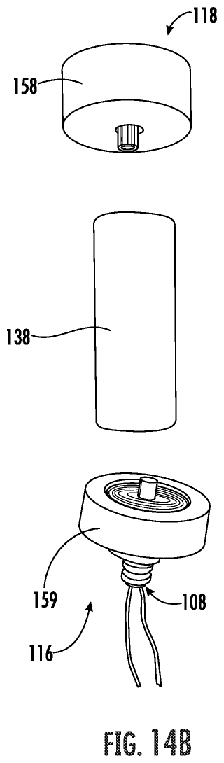

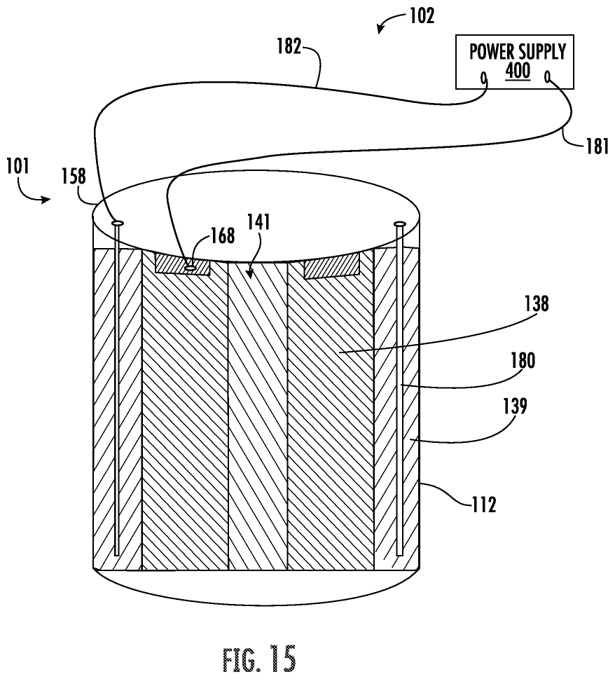

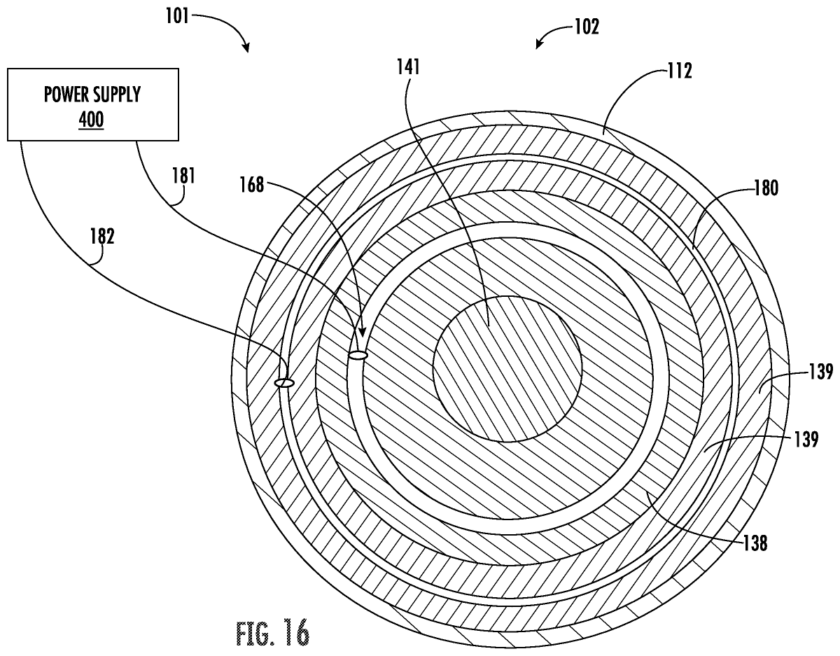

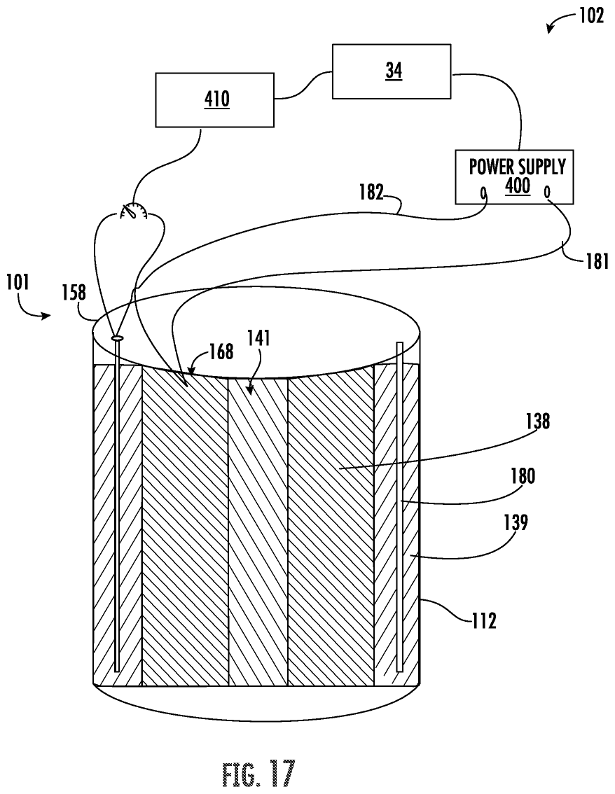

Referring to FIGS. 7A-7B, and FIGS. 13A-13C, and FIGS. 14A-14B, and FIGS. 15-16, embodiments of the filtration system 102 include an electrochemical configuration to remove ions, particles, debris, or other particulates from unfiltered water, such as depicted schematically as unfiltered water 139, and the filter medium 138. In various embodiments, the filter medium 138 includes a carbon or carbon-based material, such as formed as a surface, wall, block, or other structure, such as an activated carbon medium. The filtration system 102 is configured to apply a potential difference between the filter medium 138, forming a first electrode, and a second electrode 180 at the unfiltered water 139. The second electrode 180 extends into a separate volume from the filter medium 138, such as a volume at which unfiltered water 139 is positioned within the filtration housing 112. The second electrode 180 forms a rod, a plate, or other desired geometry forming a surface or wall extending into the volume. An electrolytic cell 101 is configured as a cathode electrode and an anode electrode formed from the filter medium 138 as the first electrode and the surface forming the second electrode.

In some embodiments, a first volume is formed at the filtration housing 112. The first volume forms a plenum at which unfiltered water may be received, such as a volume adjacent to a first side of the filter medium 138. A second volume forms a plenum at which water filtered through the filter medium 138 is provided, such as a volume adjacent to a second side of the filter medium 138.

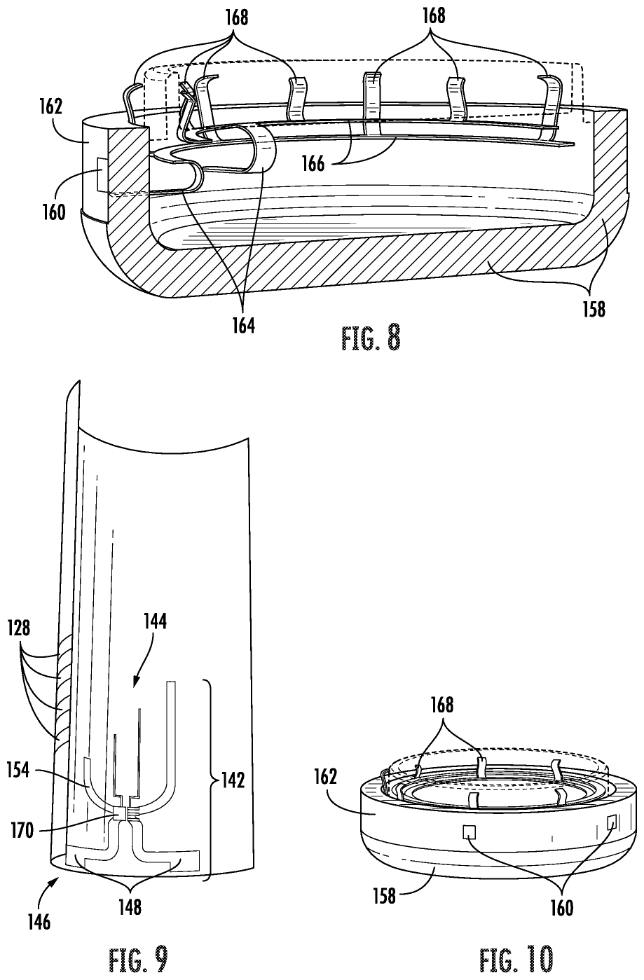

In various embodiments, a power supply, power delivery, or driving system 400 is configured to supply or deliver a controlled voltage or current output at the electrolytic cell, such as depicted in FIG. 17. In some embodiments, the power supply or power delivery system 400 forms an electronic driving system. For instance, the power supply is electrically coupled to the electrodes at the electrolytic cell 101, such as depicted via connections 181, 182 to the respective first electrode formed at filter medium 138 and the second electrode 180. In some embodiments, connections 181, 182 may form electrical wires. In still some embodiments, connections 181, 182 may include all or part of electrical connector 142, electrical contacts 128, 130, contact pad 160, conductor body 164, or other portions, such as depicted and described in regard to FIGS. 8-10.

In some embodiments, the power supply 400 is configured to selectively apply voltage or current at the electrolytic cell based on a period of time. The period of time may include one or more frequencies of application and inverse polarity of applying voltage or current at the electrolytic cell to reverse a flow of ionic current in the electrolytic cell. Reversing the flow of ionic current may form a gap between a surface of the filter medium 138 and a sediment layer formed from filtration of water through the filter medium 138 (e.g., formed from unfiltered water 139 passing through the filter medium 138 to a volume at which filtered water is positioned, such as depicted at filtered water 141. Forming the gap may remove obstructions at the filter medium 138 that may restore permeability of the filter medium 138, such as to improve the flow characteristic or maintain the flow characteristic at a desired level. Restoring permeability of the filter medium 138 may facilitate increased life and usability of the filter medium and improve flowrate or pressure drop across the filter medium.

Referring now to FIG. 17, in some embodiments, the controller 34 is operably coupled to the power supply or power delivery system 400 and a measuring system 410. In various embodiments, such as described herein, the power supply or power delivery system 400 is configured to selectively apply voltage or current to the electrolytic cell. The measuring system 410 may be configured to measure or determine a flow characteristic, such as flowrate and/or pressure drop across the filter medium 138, time-in-service or volume-in-service of the filter medium 138, or other parameter or characteristic corresponding to a quality or quantity of flow across the filter medium 138. The controller 34 may be configured to control voltage or current at the electrolytic cell based on a flow characteristic threshold. The controller 34 may be configured to receive or transmit signals from the measuring system 410, such as signals corresponding to flow characteristic. The controller 34 may further be configured to determine quantity or quality of flow across the filter medium 138.

In various embodiments, the electrolytic cell is electrically coupled to the power supply or power delivery system 400 via conductive branches 168, such as depicted and described in regard to FIGS. 8-10. Power supply or power delivery system 400 may selectively communicate voltage or current through electrical contacts 128, 130. Conductor body 165 may operably couple to electrodes to communicate voltage or current from the power supply or power delivery system 400. For instance, respective conductive branches 168 may operably contact respective electrodes such as described herein. In still various embodiments, electrical chip(s) 170 may be positioned to interrupt or change electrical communication at the electrodes, such as to selectively reverse polarity based on a frequency or period of time, or based on a flow characteristic, such as described herein.

Referring now to FIG. 18, a flowchart outlining steps of a method for self-cleaning at a fluid filter assembly is provided (hereinafter, “method 1000”). Embodiments of the method 1000 may additionally, or alternatively, form a method for maintaining or improving a flow characteristic at a fluid filter assembly, such as flow rate or pressure drop. Still various embodiments of the method 1000 may additionally, or alternatively, form a method for determining filter replacement at a filtration assembly. Embodiments of the method 1000 may be provided by embodiments of a filtration assembly such as described herein. It should be appreciated that embodiments provided herein may be performed at a standalone filtration assembly, such as a kitchen water filter assembly or a mainline (e.g., residential housing) water system, or at an appliance (e.g., a refrigeration or freezer appliance, a washing machine appliance, etc.).

Embodiments of the method 1000 include at 1010 disposing unfiltered fluid into a first volume (e.g., volume at which unfiltered water 139 is disposed) enclosed in a housing (e.g., filtration housing 112). The unfiltered fluid is in fluid communication at a first side of a filter medium (e.g., filter medium 138). A second volume (e.g., volume at which filtered water 141 is disposed) is formed at a second side of the filter medium at which filtered fluid is disposable.

Method 1000 includes at 1020 applying (e.g., via a power supply or driving system, such as power supply or power delivery system 400) a potential difference between a first electrode (e.g., electrode 188) positioned at the filter medium and a second electrode (e.g., electrode 180) positioned at the first volume.

Method 1000 includes at 1030 reversing (e.g., via a power supply or driving system, such as power supply or power delivery system 400), for a period of time, a polarity of the applied potential. Reversing the polarity reverses an ionic current at an electrolytic cell (e.g., electrolytic cell 101) including the first electrode and the second electrode.

In some embodiments, applying the potential difference includes controlling a voltage through an electrolytic cell including the second electrode and the filter medium as the first electrode. In various embodiments, controlling the voltage may include applying a first voltage, and reversing the polarity of the applied potential may include applying a second voltage having a reverse polarity relative to the first voltage. In various embodiments, the first and second voltage may be the same, similar, or different in magnitude.

In still some embodiments, applying the potential difference includes controlling a current at an electrolytic cell including the second electrode and the filter medium as the first electrode. In various embodiments, applying the current may include applying a first current. Reversing the polarity of the applied potential may include selectively applying a second current different from the first current.

In an exemplary embodiment, the voltage or current may be adjusted to increase or improve an ionic current to form a gap between a surface of the filter medium and a sediment layer that may be formed at the filter medium from filtering water. As such, forming the gap may restore permeability of the filter medium, such as to improve the flow characteristic or maintain the flow characteristic at a desired level.

In still various embodiments, the period of time over which the polarity is reversed may include a frequency over which the polarity is reversed and returned to an initial polarity. For instance, the period of time may be a predetermined period of time from which the polarity is reversed (e.g., a period of time from initial usage of the water filter assembly, or a period of time from a previous polarity reversal). In various instances, the period of time may be a predetermined period over which the polarity is reversed.

In still yet various embodiments, polarity reversal may be triggered when a determined flow characteristic (e.g., flow rate or pressure drop across between the volumes at which respective volumes of water 139, 141 are disposed exceeds a predetermined threshold). For instance, when the flow rate, or a parameter indicative thereof, decreases below the predetermined threshold, the controller 34 may command the power supply or power delivery system 400 (e.g., via a first signal) to apply the potential difference to perform a redox reaction to form coagulated particles of dissolved particulates from the water, and command the power supply or power delivery system 400 (e.g., via a second signal) to reverse the polarity to reverse the ionic current at the electrolytic cell and form a gap of the coagulated particles at the filter medium, such as to improve permeability that may improve flow characteristic above the predetermined threshold (e.g., improve or restore flow rate or pressure drop).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for self-cleaning at a fluid filter assembly, the method comprising:
disposing unfiltered fluid into a first volume enclosed in a housing, wherein the unfiltered fluid is in fluid communication at a first side of a filter medium comprising a first electrode, and wherein a second volume is formed at a second side of the filter medium at which filtered fluid is disposable;
applying a potential difference between the first electrode at the filter medium and a second electrode positioned at the first volume; and
reversing, for a period of time, a polarity of the applied potential, wherein reversing the polarity reverses an ionic current at an electrolytic cell comprising the first electrode and the second electrode.

2. The method of claim 1, wherein applying the potential difference comprises controlling a voltage at an electrolytic cell comprising the first electrode and the second electrode.

3. The method of claim 1, wherein applying the potential difference comprises controlling a current through an electrolytic cell including the first electrode and the second electrode.

4. The method of claim 1, wherein the filter medium comprises a carbon material.

5. The method of claim 1, wherein the second electrode extends into the first volume, the second electrode comprising a conductive material.

6. A water filtration assembly comprising:
a filtration housing forming a first end distal from a second end, wherein the first end includes one or more of a fluid inlet port or a fluid outlet port fixed to the filtration housing, wherein the filtration housing forms a first volume configured to receive unfiltered water, and wherein the filtration housing forms a second volume configured to receive filtered water, wherein a first electrode comprising a filter medium is positioned at the filtration housing and separates the first volume from the second volume;
a second electrode extending into the first volume;
a power delivery system operably coupled to an electrolytic cell comprising the first electrode and the second electrode, the power delivery system configured to selectively apply a potential difference between the first electrode and the second electrode, and wherein the power delivery system is configured to selectively reverse a polarity of the applied potential.

7. The water filtration assembly of claim 6, wherein the power delivery system is configured to reverse the polarity based on potential difference between the first and second electrodes.

8. The water filtration assembly of claim 6, wherein the power delivery system is configured to reverse the polarity based on current through the electrolytic cell.

9. The water filtration assembly of claim 6, wherein the filter medium comprises a carbon material.

10. The water filtration assembly of claim 6, wherein the second electrode extends into the first volume, the second electrode comprising a conductive material.

11. The water filtration assembly of claim 6, comprising:
a controller operably coupled to the power delivery system, the controller configured to command at the power delivery system:
applying the potential difference between the first electrode and the second electrode; and
reversing, for a period of time, the polarity of the applied potential, wherein reversing the polarity reverses an ionic current at the electrolytic cell comprising the first electrode and the second electrode.

12. The water filtration assembly of claim 11, wherein the controller is configured to determine a flow characteristic across the filter medium and reverse the polarity of the applied potential based on the determined flow characteristic.

13. The water filtration assembly of claim 11, comprising:
a measuring system configured to determine a flow characteristic, wherein the controller is configured to reverse the polarity of the applied potential difference for the period of time when a flow characteristic threshold is exceeded.

14. A refrigeration appliance, comprising:
a cabinet defining a chilled chamber;
a water filtration assembly comprising;
a filtration housing forming a first end distal from a second end, wherein the first end includes one or more of a fluid inlet port or a fluid outlet port fixed to the filtration housing, wherein the filtration housing forms a first volume configured to receive unfiltered water, and wherein the filtration housing forms a second volume configured to receive filtered water, wherein a filter medium is positioned at the filtration housing and separates the first volume from the second volume;
an electrolytic cell comprising a first electrode and a second electrode, the filter medium forming the first electrode, the second electrode extending into the first volume, wherein the electrolytic cell is configured to reverse polarity to reverse an ionic current through the electrolytic cell to restore permeability at the filter medium; and
a power supply system operably coupled to the electrolytic cell, the power supply system configured to selectively apply a potential difference between the first electrode and the second electrode, wherein the power supply system is configured to selectively reverse a polarity of the applied potential.

15. The refrigeration appliance of claim 14, wherein the filter medium comprises a carbon material.

16. The refrigeration appliance of claim 14, comprising:
a controller operably coupled to the power supply system, the controller configured to command at the power supply system:
applying the potential difference between the first electrode and the second electrode; and
reversing, for a period of time, the polarity of the applied potential, wherein reversing the polarity reverses the ionic current at the electrolytic cell.

17. The refrigeration appliance of claim 16, wherein applying the potential difference comprises controlling a voltage at the electrolytic cell.

18. The refrigeration appliance of claim 17, wherein the controller is configured to reverse the polarity based on potential difference between the first and second electrodes.

19. The refrigeration appliance of claim 17, wherein the power supply system is configured to reverse the polarity based on current through the electrolytic cell.

20. The refrigeration appliance of claim 14, comprising:
a measuring system configured to determine a flow characteristic, wherein the controller is configured to reverse the polarity of the applied potential difference for the period of time when a flow characteristic threshold is exceeded.
